(19) United States
(12) Patent Application Publication
(10) Pub. No.: US 2016/0281416 A1
(43) Pub. Date: Sep. 29, 2016

(54) CLASSROOM RETROFIT BARRIERS

(71) Applicant: DAW Technologies, LLC, Salt Lake City, UT (US)

(72) Inventor: Peter J. Spransy, Salt Lake City, UT (US)

(21) Appl. No.: 15/077,817

(22) Filed: Mar. 22, 2016

Related U.S. Application Data
(60) Provisional application No. 62/136,902, filed on Mar. 23, 2015.

(51) Int. Cl. E06B 5/10; E05C 19/00; E04H 9/06; F41H 5/24

(52) U.S. Cl. CPC E06B 5/10; F41H 5/24; E05C 19/00; E04H 9/06

(57) ABSTRACT

A ballistic door providing barrier-of-entry shielding blocks a doorway in certain emergency situations to shield against active shooters, while not inhibiting, impeding, or changing the safe egress through the ballistic door. A ballistic assembly may be secured to the non-threat side of an existing door, by retrofit installation or by new construction installation. The ballistic assembly has a ballistic skin, a top ballistic skin clamp, and a bottom ballistic skin clamp. The top and bottom ballistic skin clamps secure the ballistic skin against the non-threat side of the door. The ballistic door has at least a N.I.J. Level IIIA of protection against gunfire.

### TECHNICAL FIELD

This patent application claims the benefit of U.S. Provisional Patent Application Ser. No. 62/136,902 that was filed on Mar. 23, 2015, for an invention titled CLASSROOM RETROFIT BARRIER.

### TECHNICAL FIELD

The present invention relates generally to ballistic barriers. More specifically, the present invention relates to a system and method for retrofitting an entryway to a classroom or the like.

### BACKGROUND

In today's society there has arisen a need to provide protection for students against active shooters (gunmen) attacking defenseless victims on school campuses. There are many approaches being considered for such protection including but not limited to; more campus police, arming teachers, ballistic backpacks, etc.

One approach is disclosed in U.S. Pat. No. 9,145,729 entitled Classroom Ballistic Barriers, issued Sep. 29, 2015 to DAW Technologies, LLC, where the barrier system comprised a ballistic panel nested slidably in upper and lower channels to slide across a doorway and lock into position. The sliding ballistic panel operates independent of the classroom door and manually must be slid across the doorway opening. Similarly, in U.S. Pat. No. 9,234,724, also entitled Classroom Ballistic Barriers and issued Jan. 12, 2016 to DAW Technologies, LLC, a barrier system comprised of one or more ballistic panels slide across door or window openings to provide ballistic shielding against attacks through such openings. Again, the sliding ballistic panels operate independent of the classroom door or window and manually must be slid across the opening. Such systems and other efforts to shield students from active shooters have their drawbacks. Many such systems are made of expensive materials and can be time-consuming and expensive to install. Also, they may compromise the ability to make an emergency exit from the classroom.

What is needed is a ballistic shielding solution that is effective, requires minimal effort to deploy, and is cost-effective for schools or office buildings to purchase and install. The embodiments of the present disclosure may cost-effectively turn almost any classroom into a “safe room”. Creating “safe rooms” on campuses drastically reduces or eliminates the “opportunity” and permits trained professionals adequate time to respond to the threat. The retrofit barrier of the present disclosure has a non-alarming appearance to students; it is simple to operate; it is be bullet resistant; and it prevents breaching for some predetermined length of time, thus allowing time for local police/SWAT to respond.

### SUMMARY OF THE INVENTION

The classroom ballistic barriers of the present disclosure provide barrier-of-entry shielding that may be retrofit to the existing classroom door by the school's own maintenance staff and will not inhibit emergency exits through the door. The system and method of the present disclosure combines a minimally-thick ballistic skin with a solid-core wood as is typically used as a classroom door to create a shield equivalent to a N.I.J. Level IIIA ballistic panel. Hence, it is possible to retrofit a relatively thin ballistic skin onto an existing door to provide protection against multiple 0.44 magnum and 9 mm handgun blasts, as well as multiple 12-gauge shot gun blasts. The ballistic skin comprises ballistic fiberglass reinforced plastic (FRP) material. N.I.J. Level IIIA protection must stop five rounds from a 0.44 magnum or five rounds from a 9 mm handgun within a 12″×12″ square shot 16 feet 4 inches away, with no penetrations. Normally, to achieve N.I.J. Level IIIA protection with this type of material, it would require a minimum of a ½″ thickness. Because this material weighs approximately 6 pounds per square foot, providing that thickness would add too much weight to the door, would make it difficult for a single maintenance person to install, and would add unnecessary cost. However, by applying the ballistic skin of a ¼″ thickness to an existing door, the weight of the ballistic shielding is cut in half making it capable of installation by a single maintenance person, and the cost of the shielding is significantly reduced. Moreover, by using lightweight (thinner) ballistic material, the added weight will not fatigue the existing door, nor will the shielding protection provided be exorbitantly expensive for schools.

In an exemplary embodiment, mechanical fasteners are used to ensure that the door will perform consistently against ballistic threats versus adhesive or double-sided adhesive tape. The adhesives suitable for securing the ballistic skin to a typical classroom door can vary greatly depending upon the substrate or substrate preparation. Hence, to use adhesives to secure the ballistic skin to the door can add unnecessary complexity to a retrofit installation. By using mechanical fasteners, a residing maintenance worker for each school and/or office building is likely skilled sufficiently to install the ballistic skin to the door. Furthermore because it is imperative that the ballistic performance not be compromised because of inattention to detail, retrofit installations using mechanical fasteners is preferred. In short, the mechanical fasteners make for a fool-proof installation.

The ballistic skin is custom fit to each door with an array of holes predrilled into the skin enabling the installer to use the skin as a drill template during installation. The array of holes are spaced from the outer boundary edges of the ballistic skin and the number and position of the holes assure that the ballistic performance is not compromised and the ballistic skin remains secured to the door during a gunfire attack. To permit the existing door to properly close without the need for any modification of door or jambs, the ballistic skin is held spaced from the edges of the door so that the edges of the ballistic skin abuts the periphery of the jamb. Top and bottom ballistic skin clamps are provided to ensure a tight connection between the door and the ballistic skin without the need of any adhesives. Ballistic fiberglass reinforced plastic (FRP) is difficult to bond to since it has a relatively “greasy” surface, so using mechanical fasteners and the top and bottom skin clamps solve any bonding issues. The mechanical fasteners are tamper resistant through-bolts that are secured from classroom, non-threat side of the door. In some embodiments, the use of sex-bolts ensures that the fastener cannot be compromised from the hall, threat side of the door.

It should be understood, however, that the systems and methods of the present disclosure may also be used in new construction and in total door replacement situations. In these types of installations, it may be preferable to use an adhesive attachment of the ballistic skin to the door. Those skilled in the art will understand what types of adhesives would be suitable. Also, in the instance of total door replacement, the residing maintenance worker is likely capable of installing the replacement door, and in new construction, a qualified construction worker will handle the construction and hanging of the ballistic door.

If the door has a window, the window is replaced with a ballistic glazing and frame so that the ballistic panel overlaps at the joint between the door and the ballistic glazing. The ballistic glazing is fixed in place by the ballistic frame, comprising both an interior frame portion and an exterior frame portion, to ensure that the ballistic protection extends over the entire door area.

To shield the latch area of the door, a latch guard (hallway, threat side) and a latch support (classroom, non-threat side) are incorporated to protect the door against forced entry. With minimal alteration, the ballistic skin, a modified latch guard, and modified latch support may be fit onto a door that has panic hardware or fit panic hardware onto a door that has been retrofit with this ballistic skin. Those skilled in the art, armed with this disclosure would be able to make the minimal alterations to accommodate panic hardware.

The classroom ballistic barrier can be a sliding panel or hinged panel depending upon the configuration of the door opening or window opening to be blocked. The barrier must not inhibit, impede, or change the egress through the door. It must be simple to operate, it must be bullet resistant, and lastly it must be impenetrable for some predetermined length of time.

Because the barrier is located inside the door opening (for someone looking down a long hallway) it will not be immediately obvious which rooms are the “safe rooms.”

The ballistic barrier of the present disclosure is always in position whenever the door is closed and locked (in a normal locking fashion). The ballistic barrier in no way inhibits, impedes, or changes the safe egress through the door.

To accommodate various types of classroom or office building doors, the ballistic skins can be made to suit each type of these typical doors. Also, the classroom/office side of the ballistic skin may be made in various finishes to blend into the surroundings. In some embodiments, the ballistic skin may be covered with cork or a white board material. Hence, the classroom barrier can be disguised as a simple bulletin board for everyday use so as not to unduly alarm young students or inform would be assailants of its existence.

It has been considered that many different materials could be utilized in place of the ballistic fiberglass depending upon the likely threat, the desired complexity of the install, and response time of local law enforcement. Such materials are known to those of skill in the art.

### BRIEF DESCRIPTION OF THE DRAWINGS

The manner in which the above-recited and other features and advantages of the disclosed exemplary embodiments are obtained will become more fully apparent from the following description and appended claims, taken in conjunction with the accompanying drawings. Understanding that these drawings depict only exemplary embodiments and are, therefore, not to be considered limiting of the scope of this disclosure, the exemplary embodiments of this disclosure will be described with additional specificity and detail through use of the accompanying drawings in which:

FIG. 1 is an elevation view from inside a room showing an exemplary ballistic barrier panel as applied to the inside of a classroom door.

FIG. 2 is an elevation view of the opposite side of the classroom door depicted in FIG. 1 showing the side outside of the classroom as in a hallway or the like.

FIG. 3 is a side elevation view of the classroom door depicted in FIG. 1 showing the door latch and protections at the door latch.

FIG. 4 is an elevation view of the classroom door depicted in FIG. 1 showing various section view references.

FIG. 5 is a perspective view of a portion of a door showing the outside door knob and latch guard used to inhibit tampering and/or opening the door when locked.

FIG. 6 is a perspective view of a portion of a door showing the inside door knob and latch support used to shield the door knob ballistically and to inhibit tampering and/or opening the door when locked.

FIG. 7 is horizontal section view of the classroom door of FIG. 4 viewed along line D-D above the door knob.

FIG. 8 is a horizontal section view of the classroom door of FIG. 4 viewed along line A-A showing the section of the interface of the door to an inset ballistic window.

FIG. 9 is a vertical section view of the classroom door of FIG. 4 viewed along line B-B showing the top ballistic skin clamp securing the ballistic skin.

FIG. 10 is a vertical section view of the classroom door of FIG. 4 viewed along line C-C showing the bottom ballistic skin clamp securing the ballistic skin.

FIG. 11 is a perspective view of an open doorway showing another exemplary embodiment of a shielded classroom door with panic hardware.

FIG. 12 is a perspective view of an open doorway showing yet another exemplary embodiment of a shielded classroom door with alternative panic hardware.

REFERENCE NUMBERS

| | |
|---|---|
| ballistic door 10 | existing door 11 |
| door latch 12 | threat side 13 |
| door knob 14 | non-threat side 15 |
| inset window 16 | ballistic assembly 17 |
| ballistic skin 18 | top ballistic skin clamp 20 |
| bottom ballistic skin clamp 22 | ballistic glazing or window 24 |
| ballistic frame 26 | interior frame portion 28 |
| exterior frame portion 30 | mechanical fasteners 32 |
| peripheral edges 34 | outer boundary edges 36 |
| joint 38 | latch guard 40 |
| latch support 42 | panic hardware 44 |
| array of holes 46 | plurality of holes 48 |
| through-holes 50 | set of holes 51 |
| window void 52 | aligning holes 54 |
| latch void 56 | |

### DETAILED DESCRIPTION

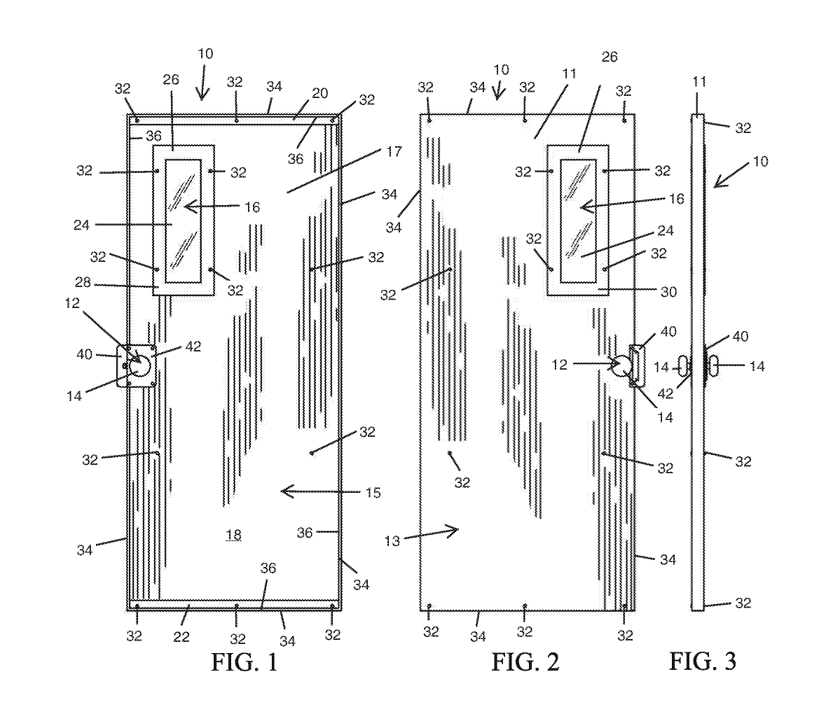

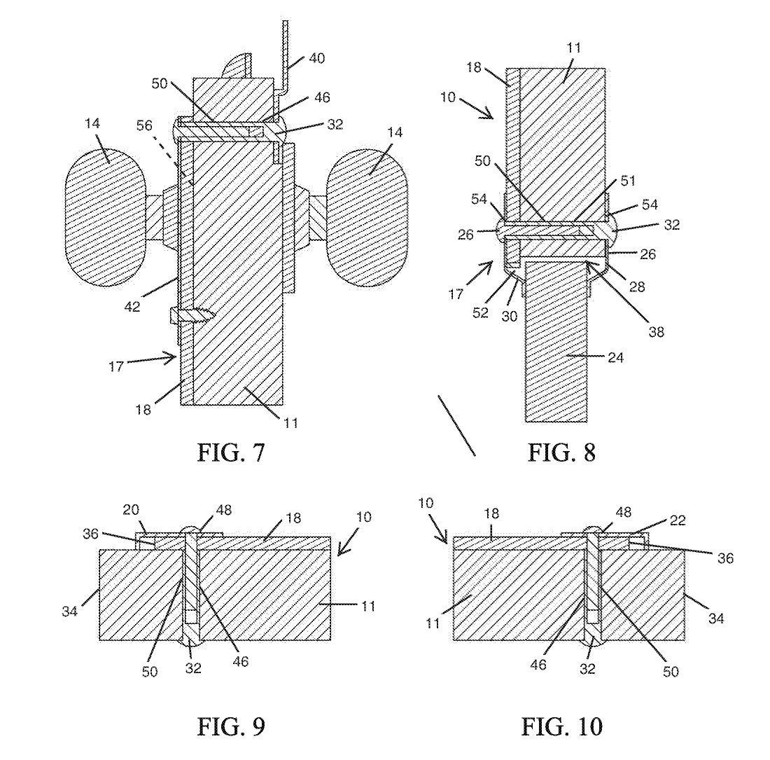

Exemplary embodiments of the present disclosure will be best understood by reference to the drawings, wherein like parts are designated by like numerals throughout. It will be readily understood that the components of the exemplary embodiments of the present disclosure, as generally described and illustrated in the Figures herein, could be arranged and designed in a wide variety of different configurations. Thus, the following more detailed description of exemplary embodiments of the apparatus, system, and methods of the present disclosure, as represented in FIGS. 1 through 12, is not intended to limit the scope of the invention, as claimed, but is merely representative of exemplary embodiments.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The classroom ballistic barriers of the present disclosure are ingress barriers comprising at least one ballistic panel specifically designed to block entry through a locked classroom door or any other door where warding off an armed assailant is desirable.

Turning to FIGS. 1-4, elevation views of an exemplary ballistic shield for a classroom door or any other door where such shielding would be desired are shown. FIG. 1 shows a ballistic door, generally designated 10, as viewed from inside a room. The ballistic door 10 comprises and existing door 11 having a door latch 12 with a door knob 14 and an inset window 16. The existing door 11 also having a threat side 13 and a non-threat side 15. The exemplary embodiment of the ballistic door 10 also has a ballistic assembly 17 that may comprise a ballistic skin 18, a top ballistic skin clamp 20, a bottom ballistic skin clamp 22, a ballistic window 24, and a ballistic frame 26, comprising both an interior frame portion 28 and an exterior frame portion 30 (not shown in FIG. 1, see FIG. 2) that are secured to the existing door 11. The ballistic skin 18, the top ballistic skin clamp 20 and the bottom ballistic skin clamp are secured to the non-threat side 15 of the existing door 11, while in cases where the existing door 11 has an inset window 16, the ballistic frame 26 captures the ballistic window 24 (replacing the existing window) from both the threat side 13 and the non-threat side 15.

As depicted in the Figures, the classroom ballistic barriers of the present disclosure provide barrier-of-entry shielding that may be retrofit to the existing classroom door 11 by the school's own maintenance staff and will not inhibit emergency exits through the door 11. The system and method of the present disclosure combines a minimally-thick ballistic skin 18 with a solid-core wood as is typically used as a classroom door 11 to create a shield equivalent to a N.I.J. Level IIIA ballistic panel. Hence, it is possible to retrofit a relatively thin ballistic skin 18 onto an existing door 11 to provide protection against multiple 0.44 magnum and 9 mm handgun blasts, as well as multiple 12-gauge shot gun blasts. The ballistic skin 18 may comprise ballistic fiberglass reinforced plastic (FRP) material. For N.I.J. Level IIIA protection, the door 11 and ballistic skin 18 combination, constituting the ballistic door 10, must stop five rounds from a 0.44 magnum or five rounds from a 9 mm handgun within a 12″×12″ square shot 16 feet 4 inches away, with no penetrations. Normally, to achieve N.I.J. Level IIIA protection with this type of material, it would require a minimum of a ½″ thickness of FRP. Because FRP material weighs approximately 6 pounds per square foot, providing that thickness would add too much weight to the door 11, would make it difficult for a single maintenance person to install, and would add unnecessary cost. However, by applying the ballistic skin 18 of a ¼″ thickness to an existing door 11, the weight of the ballistic shielding is cut in half making it capable of installation by a single maintenance person, and the cost of the shielding is significantly reduced. Moreover, by using lightweight (thinner) ballistic material, the added weight will not fatigue the existing door 10, nor will the shielding protection provided be exorbitantly expensive for schools, offices, or the like. The use of lightweight (thinner) ballistic material, while not surrendering ballistic integrity for the door, is possible by always placing the ballistic material on the non-threat side of the door. This enables the solid core wood door to assist with and perform some of the work if stopping bullets.

In the exemplary embodiment shown in FIGS. 1-4, mechanical fasteners 32 are used to ensure that the ballistic door 10 will perform consistently against ballistic threats versus adhesive or double-sided adhesive tape. The adhesives suitable to secure the ballistic skin 18 to a typical classroom door 11 can vary greatly depending upon the substrate or substrate preparation. Hence, to use adhesives to secure the ballistic skin 18 to the existing door 11 can add unnecessary complexity to a retrofit installation. By using mechanical fasteners 32, a residing maintenance worker for each school and/or office building is likely skilled sufficiently to install the ballistic skin 18 to the existing door 11. Furthermore, because it is imperative that the ballistic performance not be compromised because of inattention to detail, retrofit installations using mechanical fasteners 32 is preferred. In short, the mechanical fasteners 32 make for a nearly fool-proof installation.

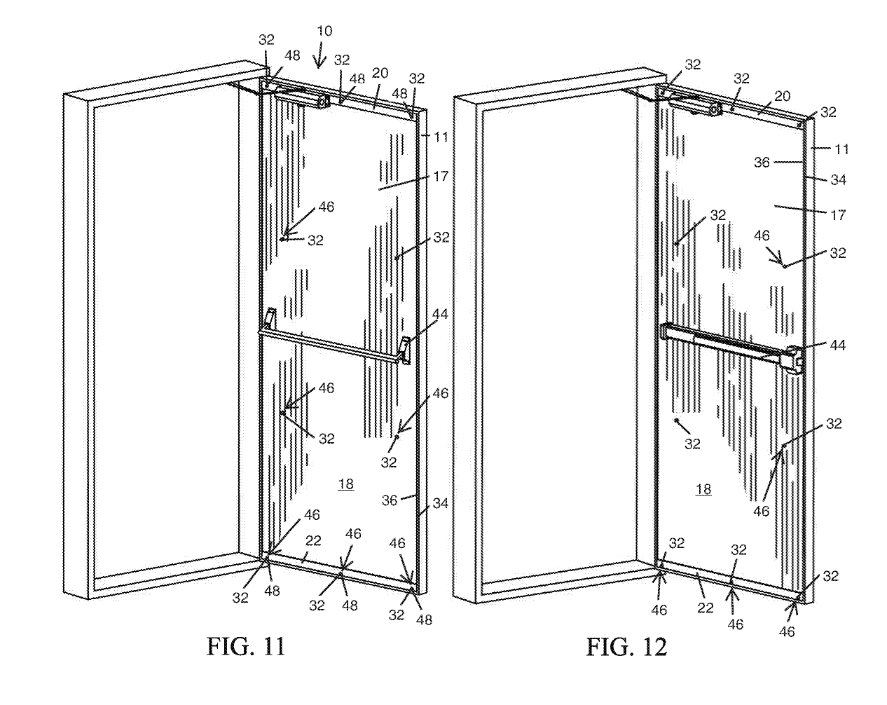

The ballistic skin 18 is custom fit to each door 11 with an array of holes predrilled into the ballistic skin 18 enabling the installer to use the ballistic skin 18 as a drill template during installation. The array of holes are spaced from the outer boundary edges of the ballistic skin and the number and position of the holes assure that the ballistic performance is not compromised and the ballistic skin remains secured to the door during a gunfire attack. To permit the existing door 11 to properly close without the need for any modification of the existing door 11 or jambs (not shown, but see FIGS. 11 and 12 for context), the ballistic skin 18 is held spaced from the peripheral edges 34 of the existing door 11 so that the outer boundary edges 36 of the ballistic skin 18 abuts the periphery of the jamb. Top and bottom ballistic skin clamps 20, 22 are provided to ensure a tight connection between the existing door 11 and the ballistic skin 18 without the need of any adhesives. As best seen in FIGS. 1, 4, 9, 11, and 12, the top ballistic skin clamp 20 is shown securing the ballistic skin 18 to the existing door 11 to preserve the peripheral spacing of the ballistic skin 18 from the peripheral edges 34 of the existing door 11 so that the outer boundary edges 36 of the ballistic skin 18 abuts the periphery of the jamb when the ballistic door 10 is closed. Similarly, as best seen in FIGS. 1, 4, and 10-12, the bottom ballistic skin clamp 22 is shown securing the ballistic skin 18 to the existing door 11 to preserve the peripheral spacing of the ballistic skin 18 from the peripheral edges 34 of the existing door 11 so that the outer boundary edges 36 of the ballistic skin 18 abuts the periphery of the jamb when the ballistic door 10 is closed.

Ballistic fiberglass reinforced plastic (FRP) is difficult to bond to since it has a relatively “greasy” surface, so using mechanical fasteners 32 and the top and bottom skin clamps 20, 22 solve any bonding issues. The mechanical fasteners 32 may be tamper resistant through-bolts that are secured from classroom non-threat side 15 of the existing door 11. In some embodiments, the use of sex-bolts ensures that the mechanical fastener 32 cannot be compromised from the hall or threat side 13 of the existing door 11.

It should be understood, however, that the systems and methods of the present disclosure may also be used in new construction and in total door replacement situations. In these types of installations, it may be preferable to use an adhesive attachment of the ballistic skin 18 to the existing door 11. Those skilled in the art will understand what types of adhesives would be suitable. Also, in the instance of total door replacement, the residing maintenance worker is likely capable of installing the replacement door 10, and in new construction, a qualified construction worker will handle the construction and hanging of the ballistic door 10.

If the existing door 11 has an inset window 16 as shown in the exemplary embodiment of FIGS. 1-4, the inset window 16 is replaced with a ballistic glazing or ballistic window 24 and a ballistic frame 26 so that the ballistic skin 18 overlaps at the joint 38 between the existing door 11 and the ballistic glazing or window 24. See FIG. 8. The ballistic window 24 is fixed in place by the ballistic frame 26, comprising both an interior frame portion 28 and an exterior frame portion 30, to ensure that the ballistic protection extends over the entire ballistic door 10 area. Like the ballistic skin 18, the ballistic frame 26 may be assembled and secured using mechanical fasteners 32, such as sex-bolts bolts to ensure that the mechanical fasteners 32 cannot be compromised from the hall side of the existing door 11.

To shield the door latch 12 area of the existing door 11, a latch guard 40 (hallway, threat side 13) and a latch support 42 (classroom, non-threat side 15) are incorporated to protect the ballistic door 10 against forced entry. An exemplary latch guard 40 is best shown in FIGS. 2 and 5-7, and an exemplary latch support 42 is best shown in FIGS. 1 and 4-7.

With minimal alteration, the ballistic skin 18, a modified latch guard 40, and modified latch support 42 may be fit onto an existing door 11 that has panic hardware 44 or panic hardware 44 may be fit onto an existing door 11 that has been retrofit with this ballistic skin 18 to transform the existing door 11 into an alternative exemplary embodiment of a ballistic door 10 with panic hardware 44. Those skilled in the art, armed with this disclosure would be able to make the minimal alterations to accommodate panic hardware 44. Two exemplary alternative embodiments of ballistic doors 10 with alternative panic hardware 44 are shown in FIGS. 11 and 12.

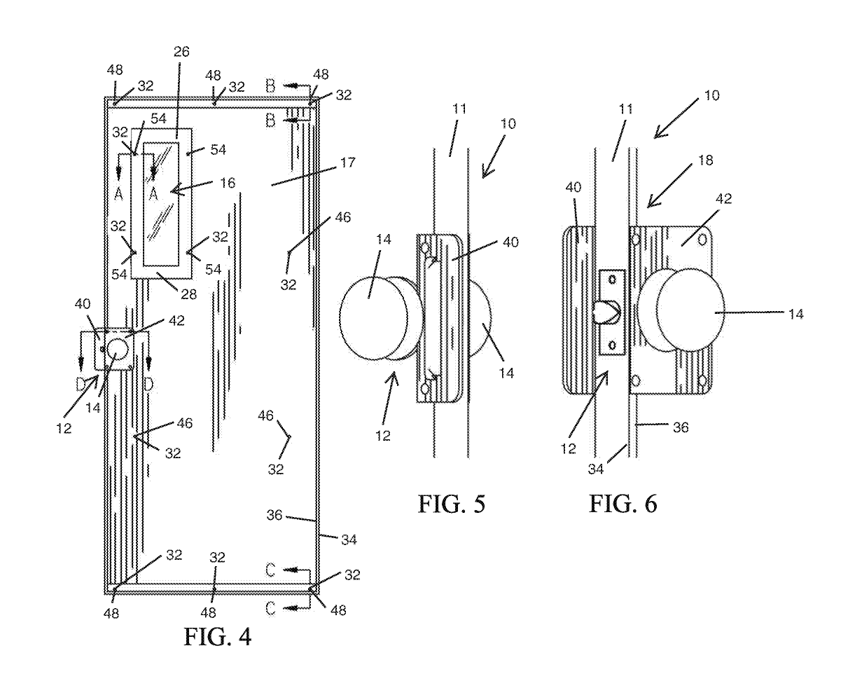

An exemplary method for preparing the ballistic assembly 17 for retrofit installation on an existing door 11 to be hung within a door jamb (see e.g., FIGS. 11 and 12) may include selecting a ballistic skin 18 having a thickness less than one-half inch and outer boundary edges 36, the thickness of the ballistic skin 18 being sufficient, when secured to the non-threat side 15 of the existing door 11, to create a ballistic door 10 having at least a N.I.J. Level IIIA of protection against gunfire. The ballistic skin 18 has a size such that the ballistic skin 18 is capable of being secured to the non-threat side 15 of the existing door 11 such that the outer boundary edges 36 are spaced from the peripheral edges 34 of the existing door 11 (see FIGS. 1 and 4) and the outer boundary edges 36 abuts the periphery of the door jamb when the ballistic door 11 is closed.

Once positioned as described above, an installer (whether a school's own maintenance staff worker or a qualified construction worker) may drill through-holes 50 through the existing door 11 by using the array of holes 46 in the ballistic skin 18 spaced from the outer boundary edges 36 as a template. See FIGS. 1 and 4. The array of holes 46 and corresponding through-holes 50 are positioned to assure that the ballistic skin 18 remains secured to the existing door 11 during a gunfire attack. For additional assurance that the ballistic skin 18 remains secured to the existing door 11, a top ballistic skin clamp 20 and a bottom ballistic skin clamp 22 each having a length less than or equal to the horizontal (or width) dimension of the ballistic skin 18 may be selected and a plurality of holes 48 may be drilled through the top ballistic skin clamp 20 and the bottom ballistic skin clamp 22 to align with top and bottom portions of the array of holes 46 through the ballistic skin 18 along the top and bottom horizontal dimensions of the ballistic skin 18, respectively, to align with the respective portions of the array of holes 46.

In some exemplary embodiments, the existing door may have an inset window 16. In such cases, an exemplary method for preparing the ballistic assembly 17 for retrofit installation on an existing door 11 may include cutting away a portion of the ballistic skin 18 that would align with the size and location of the inset window 16 to create a window void 52. A ballistic frame 26 having an interior frame portion 28 and an exterior frame portion 30 may be selected or made to have a size and shape to encase the window void 52 in the ballistic skin 18 and the inset window 16 in the existing door 11. See FIGS. 1, 2, 4, and 8. A set of holes 51 may be drilled through the ballistic skin 18 spaced from and surrounding the window void 52, and aligning holes 54 may be drilled in the internal frame portion 28 and corresponding external frame portion 30 to align with the set of holes 51 in the ballistic skin 18 that surround the window void 52. A ballistic window 24 having a size and shape to replace the inset window 16 may be cut or selected such that it may be encased within the window void 52 in the ballistic skin 18 by the ballistic frame 26.

Whether the existing door 11 has an inset window 16 or not, it will have some type of door latch 12 having door knobs 14 or panic hardware 14, for example. See FIGS. 1, 2, 4-7, 11, and 12. Preparing a ballistic assembly 17 for retrofit installation on an existing door 11 with a door latch may require cutting away a portion of the ballistic skin 18 that would align with the size and location of the door latch 12 to create a latch void 56, which may or may not include accommodating a dead bolt (not shown). A latch guard 40 may be secured to the threat side 13 of the existing door 11 to prevent jimmying the ballistic door 10 open manually or by gunfire. Also, a latch support 42 having a size greater than the latch void 56 may be secured to the non-threat side 15 of the existing door 11 to cover the latch void 56 in an overlapping fashion so that gunfire directly into the door latch 12 will not compromise the ballistic protection of the ballistic door 10.

An exemplary method of retrofit installation of a ballistic assembly 17 to an existing door 11 includes positioning a ballistic skin 18 having outer boundary edges 36 against the non-threat side 15 of the existing door 11. The ballistic skin may have a size such that the ballistic skin 18 is capable of being secured to the non-threat side 15 of the existing door 11 in a manner that the outer boundary edges 36 are spaced from the peripheral edges 34 of the existing door 11, and the outer boundary edges 36 abuts the periphery of the door jamb (not shown, but see FIGS. 11 and 12 for examples of a door jamb) when the ballistic door 10 is closed. The ballistic skin 18 may have been prepped before installation, as described above, to have an array of holes 46 through the ballistic skin 18 that are spaced from the outer boundary edges 36 and positioned to assure that the ballistic skin 18 is capable of remaining secured to the existing door 11 during a gunfire attack. Also, as described above, the ballistic skin 18 may serve as a drilling template for drilling through-holes 50 through the existing door 11 that correspond to the array of holes 46 in the ballistic skin 18. Once the through-holes 50 have been drilled, mechanical fasteners 32 may be secured through each hole of the array of holes 46 in the ballistic skin 18 and the corresponding through-holes 50 to secure the ballistic skin 18 to the non-threat side 15 of the existing door 11. Also, in some exemplary embodiments, one mechanical fastener is secured through each hole of the plurality of holes 48 in the top ballistic skin clamp 20 and the bottom ballistic skin clamp 22 aligned with holes of the array of holes 46 and corresponding through-holes 50 to clamp the top ballistic skin clamp 20 and the bottom ballistic skin clamp 22 against the ballistic skin 18.

Where the existing door 11 has an inset window 16 and the ballistic skin 18 has a window void 52 with a set of holes through the ballistic skin 18, the installer may replace the inset window 16 with a ballistic window 24 having a size and shape to replace the inset window 16. The ballistic window 24 is held in place by encasing the ballistic window 24 within a ballistic frame 26 comprised of an internal frame portion 28 with aligning holes 54 to align with the set of holes 51 in the ballistic skin 18 that surround the window void 52 and an external frame portion 30 with aligning holes 54 to align with the set of holes 51 in the ballistic skin 18 that surround the window void 52. The ballistic window 24 is secured within the ballistic frame 26 by applying mechanical fasteners 32 through each aligned hole 54 and each aligned hole of the set of holes 51 to secure the ballistic frame 26 about the ballistic window 24 and to clamp the ballistic frame 26 against the ballistic skin 18.

Additionally, the door latch 12 may be shielded against attack by securing latch guard 40 to the threat side 13 of the existing door 11 and securing a latch support 42 having a size greater than a latch void 56 in the ballistic skin 18 to the non-threat side 15 of the existing door 11 to cover the latch void 56 in an overlapping fashion.

While specific exemplary embodiments, methods, and applications of the present invention have been illustrated and described, it is to be understood that the invention is not limited to the precise configurations and components disclosed herein. Various modifications, changes, and variations which will be apparent to those skilled in the art may be made in the arrangement, operation, and details of the methods and systems disclosed herein without departing from the spirit and scope of the invention.

What is claimed is:

1. A ballistic door providing barrier-of-entry shielding for blocking a doorway in certain emergency situations to shield against active shooters, comprising:
a door having a threat side and a non-threat side; and
a ballistic assembly secured to the non-threat side of the door, comprising:
a ballistic skin;
a top ballistic skin clamp securing the ballistic skin against the non-threat side of the door; and
a bottom ballistic skin clamp securing the ballistic skin against the non-threat side of the door;
wherein the ballistic door has at least a N.I.J. Level IIIA protection against gunfire.

2. A ballistic door as in claim 1, wherein the ballistic skin comprises ballistic fiberglass reinforced plastic.

3. A ballistic door as in claim 2, wherein the ballistic skin has a thickness of at least one-quarter inch, but less than one-half inch.

4. A ballistic door as in claim 1, wherein the non-threat side of the door has peripheral edges and the ballistic skin has outer boundary edges, and the outer boundary edges are spaced from the peripheral edges.

5. A ballistic door as in claim 1, wherein the ballistic assembly is secured to the non-threat side of the door by mechanical fasteners.

6. A ballistic door as in claim 5, wherein the mechanical fasteners are secured from the non-threat side of the door and are tamper resistant from the threat side of the door.

7. A ballistic door as in claim 6, wherein at least one of the mechanical fasteners is a sex-bolt.

8. A ballistic door as in claim 5, wherein the mechanical fasteners secure the ballistic skin between the top ballistic skin clamp and the non-threat side of the door and between the bottom ballistic skin clamp and the non-threat side of the door.

9. A ballistic door as in claim 1, wherein the ballistic assembly further comprises a ballistic frame and a ballistic window, the ballistic frame comprising an interior frame portion and an exterior frame portion, the ballistic window being secured between the interior frame portion and the exterior frame portion.

10. A ballistic door as in claim 9, wherein the ballistic window is a replacement of an existing inset widow in the door and the ballistic skin overlaps the joint between the existing door and the ballistic window.

11. A ballistic door as in claim 10, wherein the door is an existing door with the window inset and the ballistic assembly is retrofitted onto the existing door.

12. A ballistic door as in claim 1, wherein the door is an existing door and the ballistic assembly is retrofitted onto the existing door.

13. A ballistic door as in claim 1, wherein the door is an existing door with a latch and the ballistic assembly further comprises a latch guard and a latch support, the latch guard disposed on the threat side of the existing door and the latch support disposed on the non-threat side of the existing door protect the existing door against ballistic and forcible entry forces being applied at the latch.

14. A ballistic door as in claim 13, wherein the latch comprises panic hardware.

15. A method for preparing a ballistic assembly for retrofit installation on an existing door to be hung within a door jamb, the existing door having a threat side, a non-threat side, and peripheral edges, the method comprising:
selecting a ballistic skin having a thickness less than one-half inch and outer boundary edges, the thickness of the ballistic skin being sufficient, when secured to the non-threat side of the existing door, to create a ballistic door having at least a N.I.J. Level IIIA of protection against gunfire, the ballistic skin having a size such that the ballistic skin is capable of being secured to the non-threat side of the existing door such that the outer boundary edges are spaced from the peripheral edges and the outer boundary edges abuts the periphery of the door jamb when the ballistic door is closed;
drilling an array of holes through the ballistic skin spaced from the outer boundary edges and positioned to assure that the ballistic skin remains secured to the door during a gunfire attack;
selecting a top ballistic skin clamp and a bottom ballistic skin clamp each having a length less than or equal to the horizontal dimension of the ballistic skin;
drilling a plurality of holes through the top ballistic skin clamp to align with a portion of the array of holes through the ballistic skin along the top horizontal dimension of the ballistic skin; and
drilling a plurality of holes through the bottom ballistic skin clamp to align with a portion of the array of holes through the ballistic skin along the bottom horizontal dimension of the ballistic skin.

16. A method for preparing a ballistic assembly for retrofit installation on an existing door as in claim 15, wherein the existing door has an inset window and the method further comprises:
cutting away a portion of the ballistic skin that would align with the size and location of the inset window to create a window void;
selecting a ballistic frame having an interior frame portion and an exterior frame portion, the ballistic frame having a size and shape to encase the window void in the ballistic skin and the inset window in the existing door;
drilling a set of holes through the ballistic skin spaced from and surrounding the window void;
drilling holes in the internal frame portion to with the set of holes in the ballistic skin that surround the window void;
drilling holes in the external frame portion to align with the set of holes in the ballistic skin that surround the window void; and
selecting a ballistic window having a size and shape to replace the inset window and be encased within the window void in the ballistic skin by the ballistic frame.

17. A method for preparing a ballistic assembly for retrofit installation on an existing door as in claim 15, wherein the existing door has a door latch and the method further comprises:
cutting away a portion of the ballistic skin that would align with the size and location of the door latch to create a latch void;
selecting a latch guard to be secured to the threat side of the existing door; and
selecting a latch support having a size greater than the latch void to be secured to the non-threat side of the existing door cover the latch void in an overlapping fashion.

18. A method of retrofit installation of a ballistic assembly to an existing door to be hung within a door jamb, the existing door having a threat side, a non-threat side, and peripheral edges, the method comprising:
positioning a ballistic skin having outer boundary edges against the non-threat side of the existing door, the ballistic skin having a size such that the ballistic skin is capable of being secured to the non-threat side of the existing door such that the outer boundary edges are spaced from the peripheral edges and the outer boundary edges abuts the periphery of the door jamb when the ballistic door is closed, the ballistic skin further having an array of holes through the ballistic skin spaced from the outer boundary edges and positioned to assure that the ballistic skin is capable of remaining secured to the door during a gunfire attack, the ballistic skin serving as a drilling template for drilling holes through the existing door;
drilling holes through the existing door at each hole of the array of holes;
selecting atop ballistic skin clamp and a bottom ballistic skin clamp each having a length less than or equal to the horizontal dimension of the ballistic skin and each having corresponding holes that align with holes of the array of holes along the top horizontal dimension of the ballistic skin and along the bottom horizontal dimension of the ballistic skin the ballistic skin respectively; and
applying a plurality of mechanical fasteners, each mechanical fastener being secured through one hole of the array of holes in the ballistic skin to secure the ballistic skin to the non-threat side of the existing door, one mechanical fastener being secured through each corresponding hole and each aligned hole of the array of holes to clamp the top ballistic skin clamp and the bottom ballistic skin clamp against the ballistic skin.

19. A method of retrofit installation of a ballistic assembly to an existing door as in claim 18, wherein the existing door has an inset window and the ballistic skin has a window void and a set of holes through the ballistic skin, the window void being aligned with the size and location of the inset window and the set of holes being spaced from and surrounding the window void, the method further comprises:
replacing the inset window with a ballistic window having a size and shape to replace the inset window;
encasing the ballistic window within a ballistic frame comprised of an internal frame portion with frame holes to align with the set of holes in the ballistic skin that surround the window void and an external frame portion with frame holes to align with the set of holes in the ballistic skin that surround the window void; and
securing the ballistic window within the ballistic frame by applying a plurality of mechanical fasteners, one mechanical fastener being secured through each aligned frame hole and each aligned hole of the array of holes to secure the ballistic frame about the ballistic window and to clamp the ballistic frame against the ballistic skin.

20. A method of retrofit installation of a ballistic assembly to an existing door as in claim 18, wherein the existing door has a door latch and the method further comprises:
securing a latch guard to the threat side of the existing door; and
securing a latch support having a size greater than a latch void in the ballistic skin to the non-threat side of the existing door cover the latch void in an overlapping fashion.
